(19) United States
(12) Patent Application Publication
(10) Pub. No.: US 2004/0264712 A1
(43) Pub. Date: Dec. 30, 2004

(54) Method and apparatus for eliminating noise in an electrical circuit

(76) Inventor: Melvin A. Lace, Prospect Heights, IL (US)

Correspondence Address: Romi N. Bose, 1157 Banyon Ct., Naperville, IL, 60540, US

(21) Appl. No.: 10/602,808

(22) Filed: Jun. 24, 2003

(51) Int. Cl. H04B 15/00

(52) U.S. Cl. 381/94.6

(57) ABSTRACT

A current flow inhibiting device or hum eliminator, such as one or more specially configured diodes or other electronic component, is placed in series with the normal ground line before it is connected to the end device. This prevents the flow of current through the ground wire. Accordingly voltages of any frequency are stopped from converting to a current flow, thereby reducing or eliminating noise in the electrical circuit and in audible signals.

### FIELD OF THE INVENTION

The present invention relates generally to noise reduction and, more particularly, to reducing the occurrence of ground-loop hum.

### BACKGROUND OF THE INVENTION

Noise is one of the single most problematic occurrences experienced during the recording and playing of music. Much of the noise is experienced as an unwanted hum or buzzing sound that is created when a musician plays through two or more grounded amplifiers. Similarly, the hum that interferes with a musician's sound also adversely affects the functioning of other electronic and audio-visual devices. For example, the noise that musicians experience coming from their instrument amplifiers, may be experienced in audio-visual equipment as a hum sound as well. In addition, the hum may appear visually as interference bars on a video display.

Although hum would appear to be benign, it is known that this type of unwanted noise may lead to erratic operation, or even permanent damage, of sensitive electronic equipment, such as Hi-fi equipment, computers, monitors and the like. In addition, noise that appears as, a hum may be actually harmful or lethal to musicians.

Unwanted noise or hum is caused generally by a phenomenon referred to as a ground loop. Ground loops are typically measured in the low millivolts, yet are able to create severe problems in the various types of systems discussed above. Typically, ground loops are created when an electrical system is connected in multiple ways to the electrical ground. The hum or buzz is actually the audible signal of AC electrical systems in the 60 Hz range in the United States and in the 50 Hz range in Europe. Ground loops in power and video signals occur when some components in the same audio/visual system are receiving their power from a line having a different ground than other components. Similarly, a ground loop may be created if the ground potential between two pieces of equipment is not alike.

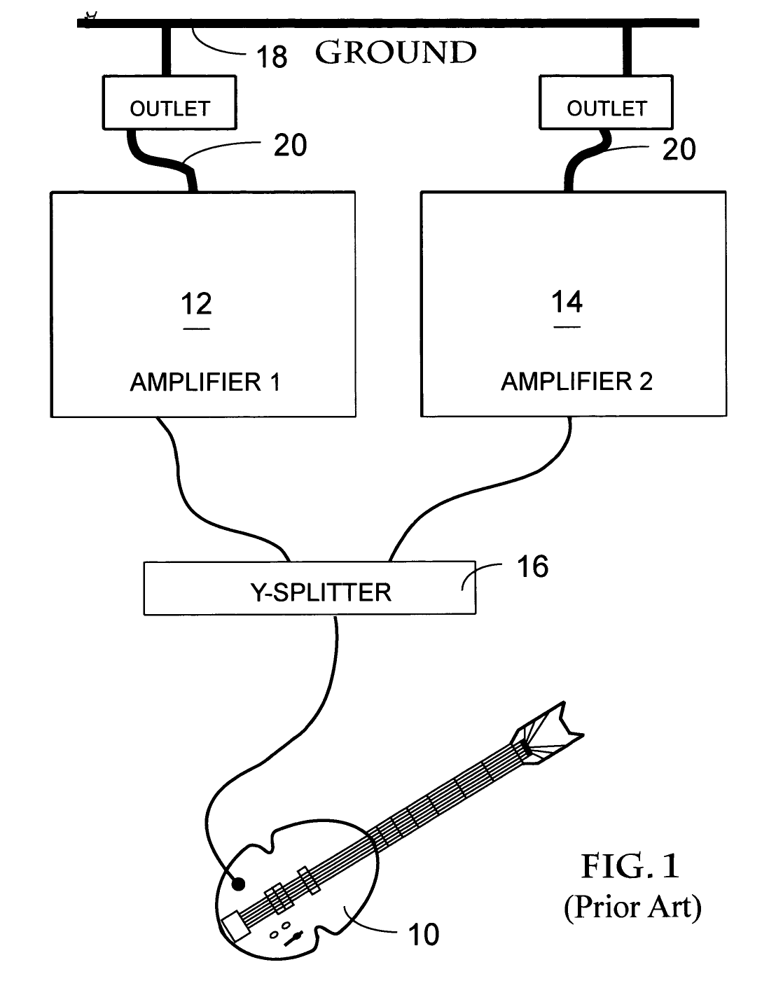

In the case of an audio system connected to two different points in a facility where there is a ground voltage situation, there may be an introduction of hum into the amplifiers. This is the case, as shown in FIG. 1 for example, when a single guitar 10 is connected to two amplifiers 12, 14 using a splitter cable 16. Because each amplifier 12, 14 has a solid bond to ground 18 and the amplifiers 12, 14 are connected by a shielded wire (the shield is grounded to each amp) 20, 20′, there is a current flow through the shield. This results in a small voltage appearing across the shield since there is a finite resistance in the shield and there is a current flowing through the ground system. This hum voltage is in series with the signal voltage and is thus amplified the same as the signal, resulting in a poor signal to noise ratio.

Apart from the potential damage to electronic equipment or unwanted noise during musical performances, musicians go to great lengths to minimize or eliminate such noise to enhance the quality of their sound. In the process, they expose themselves to potentially painful or lethal shock hazards. For example, guitarists commonly engage in the practice of using three-wire to two-wire converters (cheater plugs) or disconnecting power-cord ground pins form at least one of their amplifiers to remove or break the ground connection. This eliminates the current flow and therefore no voltage is introduced into the ground wire shield. Therefore no hum is produced. However, the consequences of this are that the amplifier is potentially deadly to anyone touching it and requires very careful connecting and disconnecting of the equipment.

Many attempts have been made over the years to eliminate ground loop hum. Unfortunately, most of these attempts have resulted in noise reduction systems that result in impedance mismatches or distortion.

### DESCRIPTION

In order to address the need for substantially reducing all hum without causing a dangerous condition and therefore protecting the operator of the equipment, preventing the flow of current through the ground wire is accomplished as follows: A current flow inhibiting device or hum eliminator, such as one or more specially configured diodes or other electronic component, is placed in series with the normal ground line before it is connected to the end device. This allows for voltages of any frequency to be stopped from converting to a current flow thereby reducing or eliminating electrical noise in the electrical circuit and in audible signals.

Thus, the hum eliminator may be used for ground protection in a power conditioner or similar device. Because computers are becoming faster, smaller, and are operating at lower and lower voltages, they require more protection. This protection is extremely important in the ground line. Many systems are used to perform this function, such as adders, common mode chokes, and various 2 and 3-coil choke configurations. All of these are for high frequencies and for transient protection. However, they are unable protect against common line frequency ground currents.

Consideration of common line frequency ground currents is very important. Since a lightning hit can produce high currents that will couple into various circuits, resulting in data loss, damage, fire, etc., the reduction of these currents is fundamentally sound from the protection standpoint. The hum eliminator is capable of reducing the transient currents to zero in most cases. As a result, there is a near total reduction of damaging ground currents at all times. Furthermore, in all cases the protection system affords very wide frequency protection and totally stops any ground transients.

In operation, the current flow inhibiting device (“hum eliminator”) is plugged into a power outlet and the electronic device, such as a guitar amplifier for example, is plugged into the hum eliminator. Advantageously, additional amplifiers do not need to be plugged into the same outlets. An additional advantage of the hum eliminator is its ability to eliminate transient currents or reduce them to almost zero. Significantly, when used with a machine that generates its own ground line transients, the hum eliminator also prevents those transients from propagating into other systems connected to the same line. Still another advantage of the hum eliminator circuitry is its small size. Thus, although the hum eliminator is described below configured as an external device to enable noise reduction in all presently available devices, the hum eliminator circuitry is small enough that it may in the future be integrated into countless different electrical and electronic devices that are susceptible to damage or malfunctions caused by electrical noise. In this manner, additional cost savings are realized by the end-user.

As described in detail below, the hum eliminator circuit uses the unique characteristics of diodes to allow for the existence of small voltages between ground and neutral but prevents the flow of any current. Various safety laboratories consider voltages up to five volts RMS on the ground line as being safe for a user. Thus, the hum eliminator, if needed, may be configured to allow up to five volts on the ground line with anti-parallel avalanche diodes or other current limiting components.

The diodes have a stand off voltage of 0.7 volts, and can also be connected in series to allow for higher voltages. Advantageously, to maintain the safety benefits provided by having a grounded connection, current flow through the ground line is allowed once a particular voltage is exceeded. Thus, current flow in the ground line at low voltage levels is blocked. Should voltage levels increase to a particular level, the diode enables current to flow, thereby maintaining the safety advantages of the ground connection. It is clear then that the hum eliminator blocks low level current that can create audible and electrical noise, but higher level currents that can potentially harm the performer or damage sensitive equipment is allowed to safely pass through the ground wire.

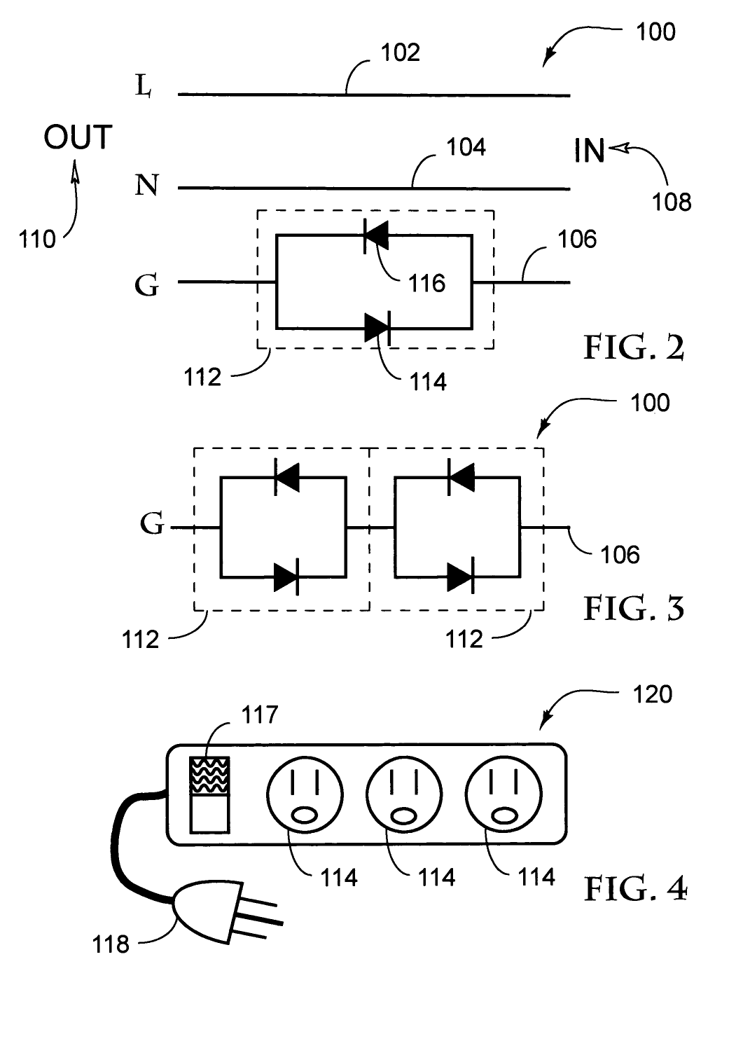

FIG. 2 shows a first embodiment of the hum eliminator 100 configured in a very basic form. In particular, the hum eliminator 100 includes a hot or live wire 102, a neutral wire 104 and a ground wire 106. The hot wire 102 and the neutral wire 104 are simply passed through from the input side 108 to the output side 110. The ground wire 106, however, is uniquely configured to have the hum eliminator circuitry attached to it. As shown, the hum eliminator circuitry 112 includes a pair of diodes 114, 116 in an anti-parallel configuration. That is, the diode pair as a unit is connected in serial with the ground line, but the individual diodes are located parallel to one another, but oriented such that the cathode of the first diode inputs to the anode of the second diode. Such a configuration is ideal for a majority of all musical applications or other applications where ground noise is not excessively high.

In another embodiment, as shown in FIG. 3, the hum eliminator 100 is configured with two diode pairs 112 connected in series on the ground line. This creates a 1.5 volt voltage drop and is ideal for use in high ground noise applications. Both embodiments of the hum eliminator 100 may be packaged in various different types of packages. For example, in a single outlet configuration (not shown), the hum eliminator is simply plugged into a wall outlet and the electrical device is plugged into the hum eliminator. An optional circuit breaker or fuse for overload protection also may be provided. The single outlet configuration also may be implemented in a wall mountable casing, commonly referred to as a “wall-wart”. The wall-wart could also include other electronic components such as transformers or the like.

As shown in the embodiment of FIG. 4, the hum eliminator is configured for use in a multiple outlet type package 120, which is familiar to consumers. The hum eliminator appears externally as a power strip having multiple 3-prong outlets 114 and a 3-prong plug 118 that is inserted into a wall socket (not shown) having a ground. An optional fuse or breaker 116 is provided as well. Furthermore, the hum eliminator circuit may be disposed within a surge protection or power conditioning device as well.

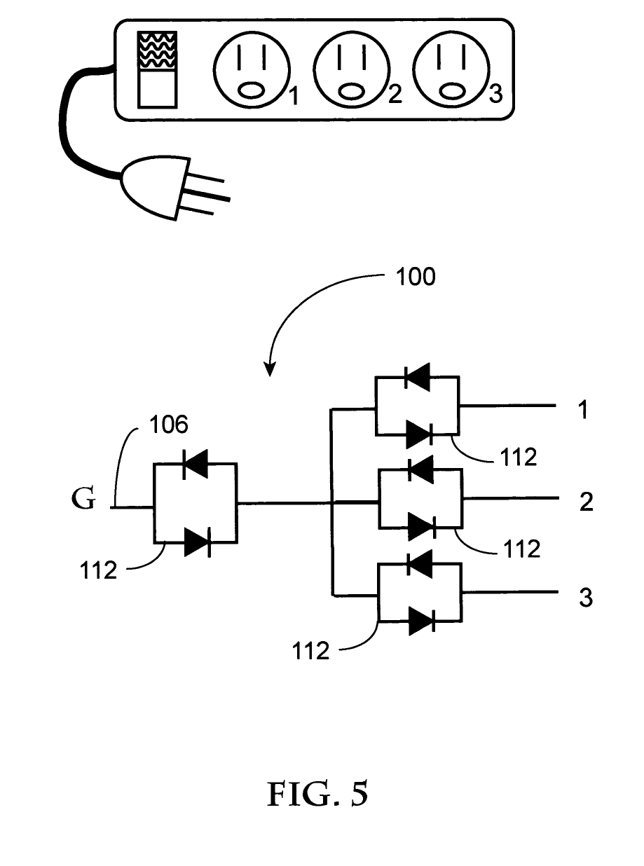

Internally, the hum eliminator circuitry used in the multiple outlet type system is quite similar to the hum eliminator used in the single outlet system described above. For example, in the exemplary embodiment shown in FIG. 5, the hum eliminator 100 is configured such that a first diode pair 112 is placed in series with the ground line 106. In addition, each of the ground wires going to each of the outlets' ground prongs includes a diode pair 112 in series with the ground wires. In this configuration, the voltage drop is 0.7 volts or 1.4 volts peak-to-peak and is intended for use in higher ground noise applications, although it works just as well in low ground noise applications.

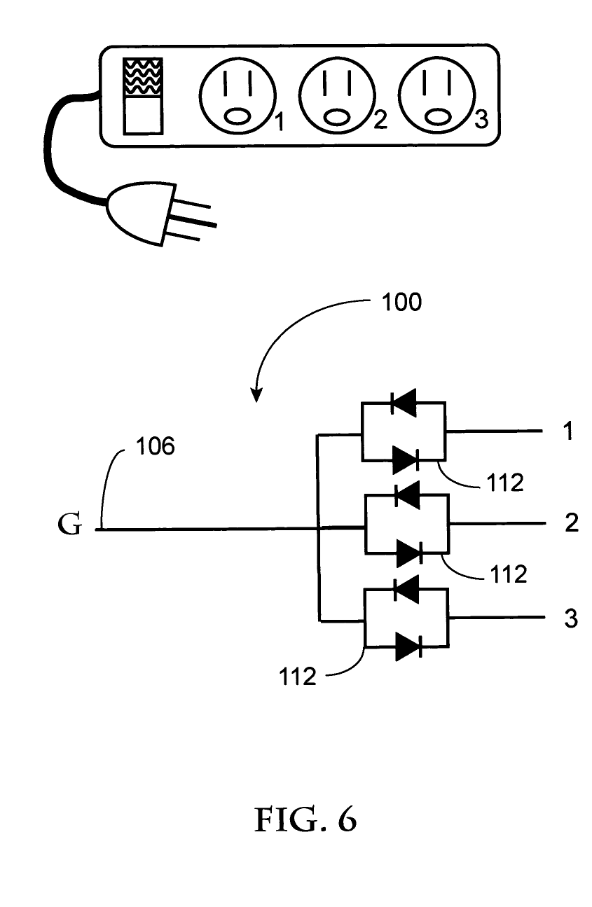

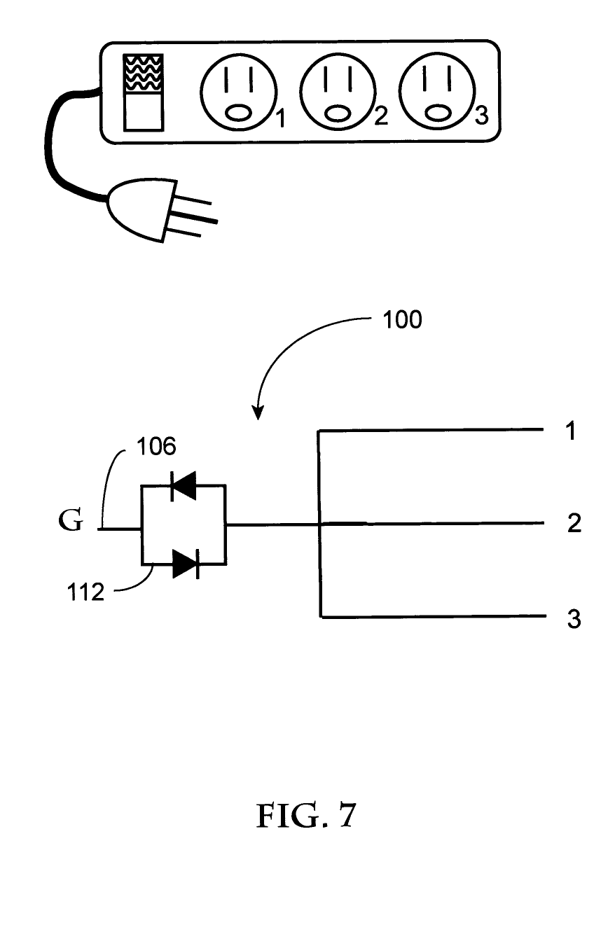

FIG. 6 depicts a configuration where each of the ground wires to the outlets includes a diode pair 112. FIG. 7 illustrates a configuration where a single diode pair is provided on the ground line.

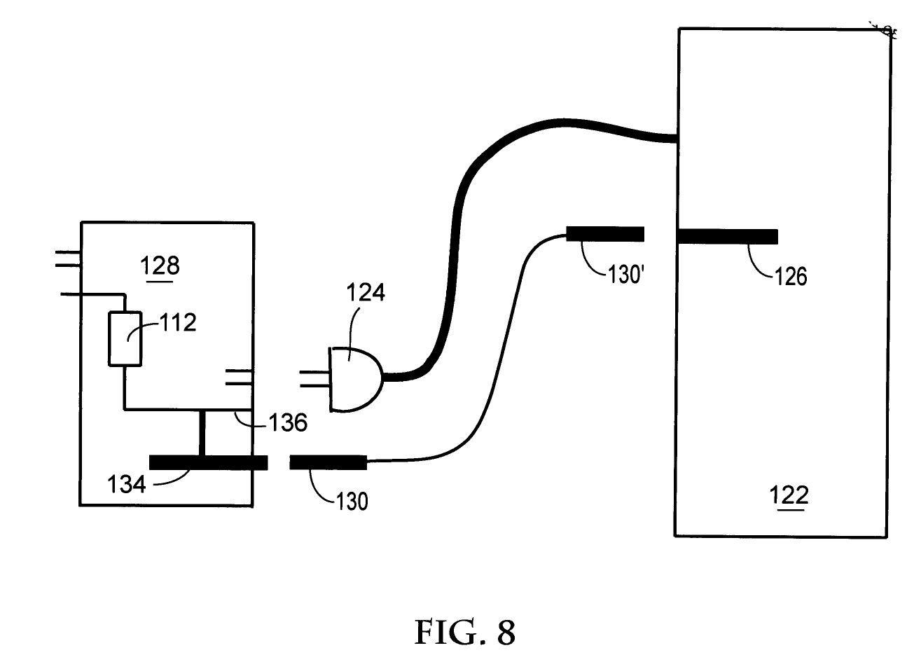

In another exemplary embodiment, as illustrated in FIG. 8, the hum eliminator is used to eliminate audible hum that may be present in an un-grounded guitar amplifier. It is thought that there are thousands of un-grounded guitar amplifiers still in circulation today. That is, these amplifiers have only two-prong plugs with no ground pin. Such amps not only may be susceptible to noise, but may also endanger the guitar player. The hum eliminator circuitry, advantageously, is configured for use even in such cases by simply connecting a cord from the line-input jack of the amplifier to the line input jack of the hum eliminator.

More particularly, FIG. 8 shows an ungrounded amplifier 122 with a 2-prong ungrounded plug 124 for providing power to the amplifier. Like all similar devices, the amplifier 122 includes one or more line-in jacks 126 into which a patch-cord is inserted for connecting a guitar with electrical pickups (not shown).

In order to eliminate hum and to enhance the safety of the ungrounded amplifier 122, the hum eliminator device 128 is configured to include an input jack 134 for receiving a first male end 130 of a patch cord 132. The other male end 130′ of the patch cord 132 is connected to the amplifier's line-in jack 126. Incidentally, it should be noted that the male end 130′ of the patch-cord 132, which goes to the amplifier 122, may be configured to include its own line-in jack into which a guitar may be plugged in. This is done because amplifiers of such early vintage rarely included more than a single input jack.

Internally, the jack 134 is electrically connected to the ground prong 136 of the hum eliminator 128. As described above, the ground plug 136 is in turn connected to the hum eliminating circuit 112, which is then connected to the ground of the electrical outlet. Therefore, in essence, the patch-cord 132 once plugged into the amplifier 122 and the hum eliminator device 128, physically acts as the missing ground wire from the two-prong plug 124.

In operation, the hum eliminator 128 enables the two-prong amplifier 122 to more safely be used by the operator and to eliminate ground noise hum essentially identically to the systems described above. That is, at low voltage levels, current flow in the ground line is blocked. However, if voltage levels increase to a particular level that is deemed unsafe, the hum eliminator circuitry enables current to flow. Accordingly, the safety advantages of the ground connection are maintained, as described above.

Although pairs of diodes were primarily discussed in discussing the techniques used in eliminating hum and electrical noise, a single diode also may be used, including a zener diode (also known as a silicon avalanche diode). In addition, other devices may be used as well, instead of a diode. Such other devices may include a metal oxide varistor or any other component that inhibits or eliminates the flow of current in a circuit up to a predetermined level. While other components may be used to inhibit current flow in the ground wire for the purposes of eliminating hum, these other components, such as a resistor, may not provide the level of safety afforded by other previously discussed components, such as a diode.

It is further to be noted that the various components described above may be used alone or in conjunction with other like or different components to provide additional features and benefits or to change the hum eliminator's operating characteristics. For example, in another exemplary embodiment, the hum eliminator is configured to function as a surge suppressor and as a noise eliminator. As such, the hum eliminator circuitry further includes a capacitor connected between the neutral and ground on the load side to provide protection against transients. Inductors are also provided, which are placed in series or partially in parallel to the hum eliminator circuitry. Varistors also may be used to provide transient protection, and are placed across the lines of the hum eliminator circuitry. For example, varistors are attached from the neutral line to ground line or from the live line to the ground line.

Although the present invention has been described with reference to certain embodiments, numerous modifications and variations can be made by those skilled in the art without departing from the novel spirit and scope of the present invention and it is intended in the appended claims to cover all those changes and modifications that fall within the true spirit and scope of the present invention.

What is claimed is:

1. A method for reducing ground loop noise, comprising:
providing an electrical power connector comprising an electrical ground;
electrically connecting a current blocking device to the electrical ground;
enabling up to a predetermined level of voltage to be present on the electrical ground; and
preventing voltage on the electrical ground from converting to a current flow using the current blocking device unless the predetermined level of voltage is exceeded.

2. The method of claim 1, further comprising the step of connecting the current blocking device in series with the electrical ground.

3. The method of claim 1, wherein the current blocking device comprises at least one diode.

4. The method of claim 3, wherein multiple diodes are configured in an antiparallel orientation.

5. The method of claim 3, wherein the diode is an avalanche diode.

6. The method of claim 5, wherein multiple avalanche diodes are configured in an antiseries orientation.

7. The method of claim 1, wherein the current blocking device clamps the voltage on the electrical ground to a predetermined level.

8. The method of claim 1, wherein the current blocking device comprises a varistor.

9. The method of claim 1, further comprising the step of integrating the current blocking device into an electronic device.

10. A device for reducing ground loop noise, comprising:
a connector for receiving electrical power, the connector comprising an electrical ground; and
a current blocking device electrically connected to the electrical ground for enabling up to a predetermined level of voltage to be present on the electrical ground and preventing voltage on the electrical ground from converting to a current flow when the predetermined level of voltage is not exceeded.

11. The device of claim 10, wherein the current blocking device is attached in series with the electrical ground.

12. The device of claim 10, wherein the current blocking device comprises a single diode

13. The device of claim 10, wherein the current blocking device comprises two or more diodes.

14. The device of claim 13, wherein the two or more diodes are configured in an antiparallel orientation.

15. The device of claim 14, wherein the diode comprises an avalanche diode.

16. The device of claim 12, wherein the current blocking device comprises two or more avalanche diodes.

17. The device of claim 16, wherein the two or more avalanche diodes are configured in an antiseries orientation.

18. The device of claim 12, wherein the current blocking device is configured to clamp the voltage on the electrical ground to a predetermined level.

19. The device of claim 12, wherein the current blocking device comprises a varistor.

20. The device of claim 12, wherein the current blocking device is integrated into an electronic device.
